(19) United States
(12) Patent Application Publication
(10) Pub. No.: US 2019/0214762 A1
(43) Pub. Date: Jul. 11, 2019

(54) CONNECTOR

(71) Applicant: KYOCERA CORPORATION, Kyoto (JP)

(72) Inventor: Shunsuke MORITA, Yokohama-shi, Kanagawa (JP)

(21) Appl. No.: 16/324,085

(22) PCT Filed: Aug. 10, 2017
(86) PCT No.: PCT/JP2017/029147

§ 371 Date: Feb. 7, 2019

(30) Foreign Application Priority Data
Aug. 10, 2016 (JP) 2016-158225

(51) Int. Cl. H01R 13/40; H01R 12/72

(52) U.S. Cl. CPC H01R 13/40; H01R 12/721

(57) ABSTRACT

A connector including a plurality of electrically conducting contacts and fitted to another connector, the connector includes: a fixing insulator having a frame shape; a plurality of metal fittings that are disposed at both ends of the fixing insulator in a contact array direction in which the contacts are arrayed, and that are provided inside the fixing insulator; and a movable insulator that is disposed inside the fixing insulator, that is connected to the fixing insulator through elastic deformation portions of the contacts, and that is movable at least in a direction perpendicular to a fitting direction of the fitting with the other connector by elastic deformation of the elastic deformation portions, both ends of the movable insulator in the contact array direction facing the respective metal fittings.

### FIELD

The present invention relates to a connector.

### BACKGROUND

Connectors connecting different substrates are known. This type of connector is configured such that a first connector attached to one substrate is fitted to a second connector attached to the other substrate. The first connector includes: a fixing insulator fixed to a substrate surface of one substrate; a movable insulator that is disposed to be movable relative to the fixing insulator; and a plurality of contacts that are mounted on the one substrate, that are held by the fixing insulator and the movable insulator, and that are arranged alongside in one direction.

Each of the contacts includes an elastic deformation portion that can be elastically deformed. In the first connector, elastic deformation of the elastic deformation portion allows the movable insulator to move relative to the fixing insulator. This can absorb positional deviation when the second connector is fitted to the first connector and allows positional deviation after the fitting. Part of the movable insulator is disposed between the fixing insulator and the substrate surface. This allows the movable insulator to be fitted to the fixing insulator when the second connector is removed from the first connector, whereby the movement of the movable insulator toward the second connector is restricted.

### CITATION LIST

### Patent Literature

Patent Literature 1: Japanese Laid-open Patent Publication No. 2014-67706

### SUMMARY

### Technical Problem

Size reduction has been demanded for the above-described connector, including reduction in the occupied area of the connector mounted on the substrate. For size reduction in the fixing insulator and the movable insulator, there is a limitation on size reduction in a contact array direction in which a plurality of contacts is arrayed because the number of contacts is fixed. In view of the above, size reduction in a width direction orthogonal to the contact array direction is conceivable. However, the size reduction in the width direction causes decrease in strength. For this reason, there is a possibility of the fixing insulator or the like being damaged when, for example, the second connector is removed from the first connector or unintentional force is applied.

For the foregoing reasons, there is a need to prevent decrease in strength while reducing the size of a connector.

### Solution to Problem

A connector according to an aspect including a plurality of electrically conducting contacts and fitted to another connector, the connector includes: a fixing insulator having a frame shape; a plurality of metal fittings that are disposed at both ends of the fixing insulator in a contact array direction in which the contacts are arrayed, and that are provided inside the fixing insulator; and a movable insulator that is disposed inside the fixing insulator, that is connected to the fixing insulator through elastic deformation portions of the contacts, and that is movable at least in a direction perpendicular to a fitting direction of the fitting with the other connector by elastic deformation of the elastic deformation portions, both ends of the movable insulator in the contact array direction facing the respective metal fittings.

The both ends of the movable insulator in the contact array direction may be formed to be wider than a central part of the movable insulator in a width direction orthogonal to the contact array direction on a plane perpendicular to the fitting direction.

Both ends of the movable insulator in the contact array direction may be restricted by the metal fittings when removed from the other connector.

The fixing insulator may include a fitting surface in the fitting direction, the fitting surface being formed of only the fixing insulator.

The fitting surface may be flat and provided in an identical plane.

The fitting surface may be flat and continuously formed on a whole circumference of the fixing insulator.

A bottom surface of the movable insulator on an opposite side of a surface fitted to the other connector may have a shape in which a distance from a virtual plane facing the bottom surface increases from a center to an end in a direction perpendicular to the fitting direction.

### Advantageous Effects of Invention

A connector has a movable insulator, both ends in a contact array direction of which face metal fittings. Thus, if the movable insulator is pulled toward another connector when the other connector is removed or unintentional force is applied, the metal fittings restrict the movement of the movable insulator in a fitting direction. As a result, since direct application of force from the movable insulator to the fixing insulator is avoided, damage to the fixing insulator can be prevented during removal or at the time of application of intentional force. The connector is provided in a state where the metal fittings are disposed inside the fixing insulator, i.e., in a state where the metal fittings are not exposed on the surface at the fitting side of the fixing insulator. Accordingly, in comparison with a case where the metal fittings are disposed on the surface of the fixing insulator, damage to other connectors caused by metallic fittings is suppressed, or unevenness of the surface of the fixing insulator is reduced. This allows the other connector to smoothly slide on the surface of the fixing insulator when the other connector is fitted to the connector, thereby making the other connector to be easily inserted into the connector. In this way, the connector may reduce its size, prevent decrease in strength, and improve fitting performance when the other connector is fitted to the connector.

### BRIEF DESCRIPTION OF DRAWINGS

FIG. 1 is a perspective view illustrating an example of a connector according to embodiments.

FIG. 2 is a perspective view illustrating an example of the connector according to embodiments.

FIG. 3 is an exploded perspective view illustrating an example of the connector according to embodiments.

FIG. 4 is a bottom view illustrating an example of the connector according to embodiments.

FIG. 5 is a diagram illustrating an example of a first connector according to embodiments.

FIG. 6 is a diagram illustrating an example of a second connector according to embodiments.

FIG. 7 is a diagram illustrating a configuration taken along A-A of FIG. 4 in cross-section.

FIG. 8 is a diagram illustrating a configuration taken along B-B of FIG. 4 in cross-section.

FIG. 9 is a side view illustrating an example of the connector according to embodiments.

FIG. 10 is a diagram illustrating the flow of assembling the first connector according to embodiments.

FIG. 11 is a diagram illustrating the flow of assembling the second connector according to embodiments.

FIG. 12 is a diagram illustrating a state where the first connector faces the second connector according to embodiments.

### DESCRIPTION OF EMBODIMENTS

With reference to the drawings, embodiments of a connector according to the present invention will be explained below. Embodiments do not limit the present invention. Components in embodiments include the ones that are straightforward and replaceable by a person skilled in the art or substantially identical ones.

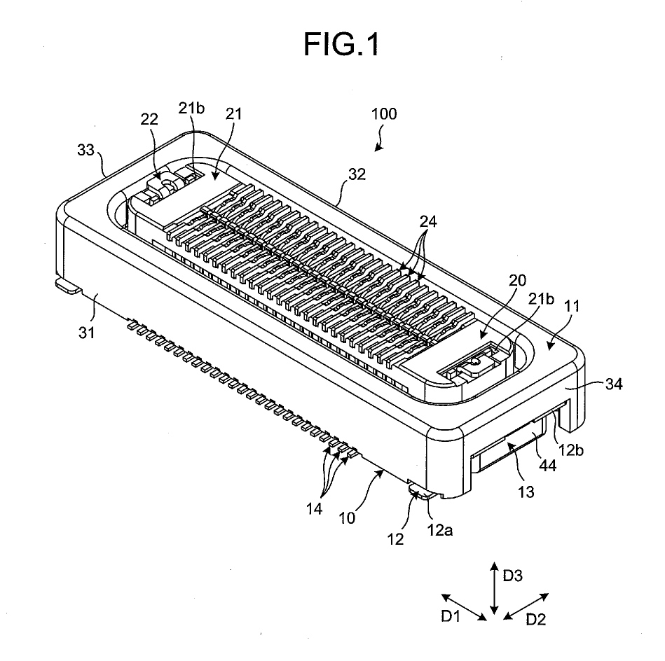

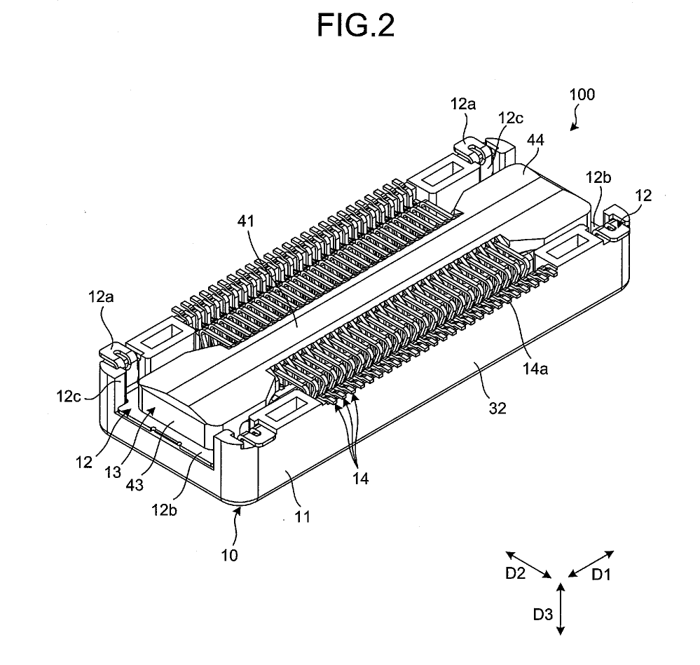

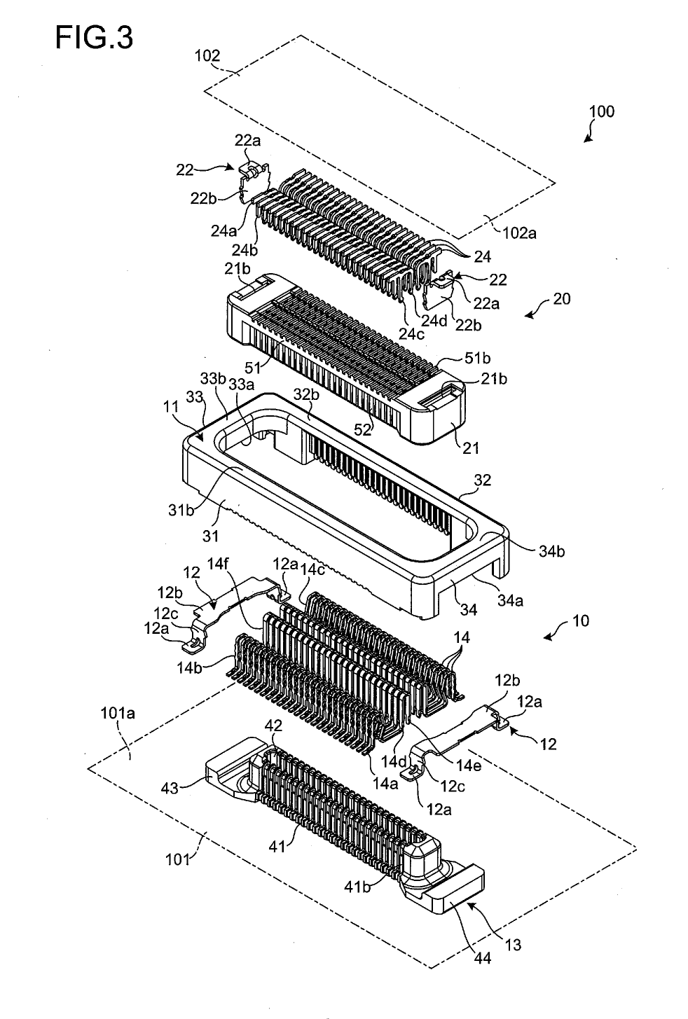

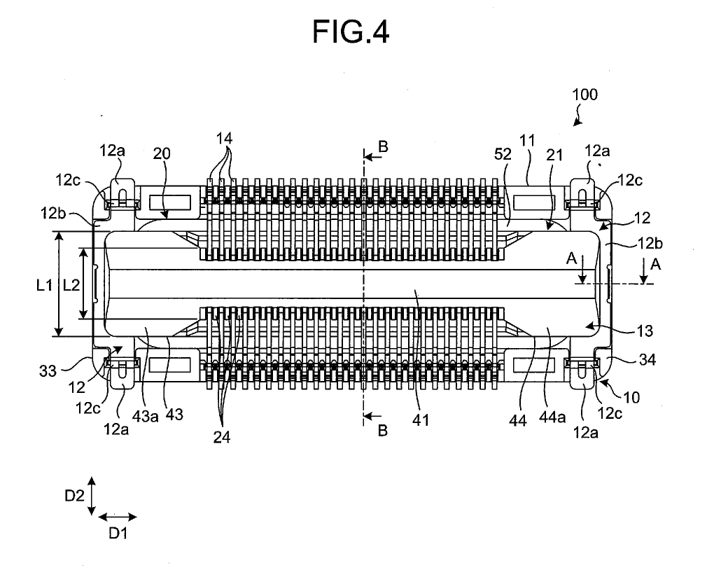

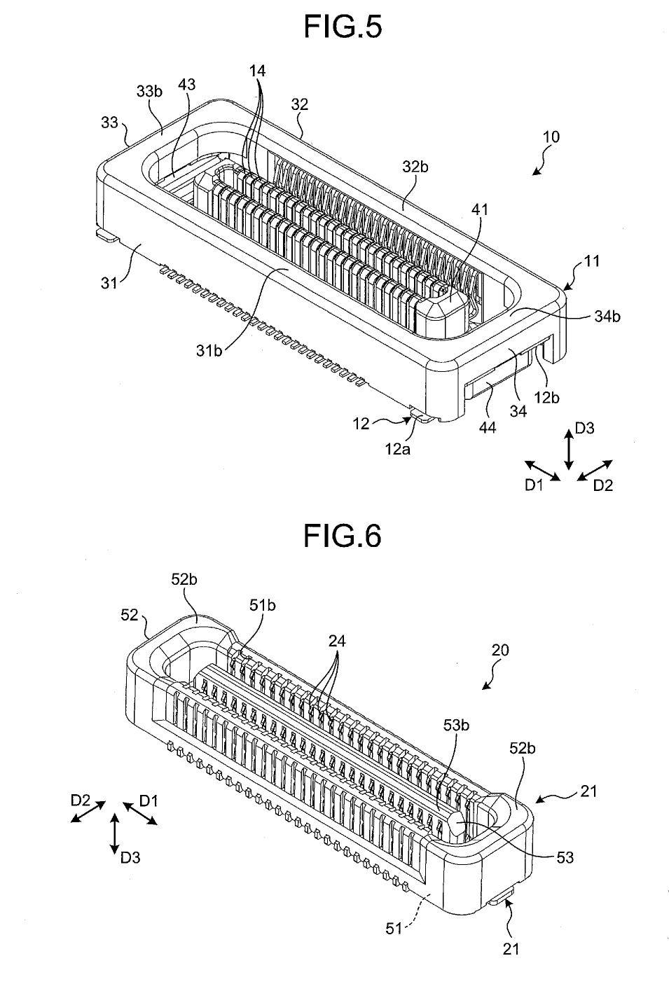

FIG. 1 and FIG. 2 are perspective views each illustrating an example of a connector 100 according to embodiments. FIG. 3 is an exploded perspective view illustrating a configuration of the connector 100. FIG. 4 is a bottom view illustrating an example of the connector 100 when viewed from a first substrate 101 side. As illustrated in FIG. 1 to FIG. 4, the connector 100 includes a first connector (connector) 10 and a second connector (another/the other connector) 20. FIG. 1, FIG. 2, and FIG. 4 each illustrate a state where the first connector 10 and the second connector 20 are fitted to each other. While embodiments refer to the connector as being configured to include the first connector 10 and the second connector 20, each of the first connector 10 and the second connector 20 is actually configured as a single connector. FIG. 5 is a diagram illustrating an example of the first connector 10. FIG. 5 illustrates the first connector 10 when viewed from a fitting surface side of the first connector 10, the fitting surface being fitted to the second connector 20. FIG. 6 is a diagram illustrating an example of the second connector 20. FIG. 6 illustrates the second connector 20 when viewed from a fitting surface side of the second connector 20, the fitting surface being fitted to the first connector 10.

The first connector 10 is fixed to the first substrate 101. The first connector 10 includes a fixing insulator 11, metal fittings 12, a movable insulator 13, and contacts 14.

The fixing insulator 11 is formed into a rectangular frame shape by using, for example, a resin material. The fixing insulator 11 is disposed with a spacing from a substrate surface 101a of the first substrate 101. The fixing insulator 11 includes a wall portion 31 and a wall portion 32, and a beam portion 33 and a beam portion 34. The wall portion 31 and the wall portion 32 are arranged in parallel to a contact array direction D1 of the fixing insulator 11. The contact array direction D1 is a direction in which the contacts 14 are arrayed in the first connector 10. The wall portion 31 is disposed on one side of the fixing insulator 11 in a width direction D2. The wall portion 32 is disposed on the other side of the fixing insulator 11 in the width direction D2. The width direction D2 is a direction orthogonal to the contact array direction D1 on the plane perpendicular to a fitting direction D3 in which the first connector 10 and the second connector 20 are fitted to each other.

The wall portion 31 includes a fitting surface 31b. The wall portion 32 includes a fitting surface 32b. The fitting surface 31b and the fitting surface 32b are plain surfaces perpendicular to the fitting direction D3. The fitting surface 31b and the fitting surface 32b are flat. The fitting surface 31b and the fitting surface 32b slidably guide the second connector 20 into the inner side of the fixing insulator 11 when the second connector 20 is fitted to the first connector 10.

The beam portion 33 and the beam portion 34 are disposed in parallel to the width direction D2. The beam portion 33 is disposed on one end side of the contact array direction D1. The beam portion 34 is disposed on the other end side of the contact array direction D1. The spacing between the beam portion 33 and the substrate surface 101a and the spacing between the beam portion 34 and the substrate surface 101a are larger than the spacing between the wall portion 31 and the substrate surface 101a and the spacing between the wall portion 32 and the substrate surface 101a. The beam portion 33 includes a support surface 33a facing the substrate surface 101a. The beam portion 34 includes a support surface 34a facing the substrate surface 101a. The support surface 33a and the support surface 34a are perpendicular to the fitting direction D3.

The beam portion 33 includes a fitting surface 33b. The beam portion 34 includes a fitting surface 34b. The fitting surface 33b and the fitting surface 34b are plain surfaces in parallel to the substrate surface 101a. The fitting surface 33b and the fitting surface 34b are flat. The fitting surface 33b and the fitting surface 34b are coplanar with the fitting surface 31b of the wall portion 31 and the fitting surface 32b of the wall portion 32. The fitting surface 33b and the fitting surface 34b, together with the fitting surface 31b and the fitting surface 32b, are continuously formed on the whole circumference of the fixing insulator 11. The fitting surface 33b and the fitting surface 34b, together with the fitting surface 31b and the fitting surface 32b, slidably guide the second connector 20 into the inner side of the fixing insulator 11 when the second connector 20 is fitted to the first connector 10.

The metal fittings 12 are disposed inside the fixing insulator 11. The metal fittings 12 are locked in a state of being inserted into the fixing insulator 11 in a direction opposite to the direction in which the second connector 20 enters. The metal fittings 12 are provided in a state of being not exposed on the fitting surface 31b, the fitting surface 32b, the fitting surface 33b, and the fitting surface 34b of the fixing insulator 11. The metal fittings 12 have a plate-like shape. The metal fittings 12 each include mounting portions 12a, an insulator support portion 12b, and insulator lock portions 12c. One of the mounting portions 12a is disposed at one end of the metal fitting 12 and another one of the mounting portions 12a at the other end of the metal fitting 12, and the mounting portions 12a are bent toward the substrate surface 101a. The mounting portions 12a are fixed to the substrate surface 101a.

The insulator support portion 12b is disposed in parallel to the plane orthogonal to the fitting direction D3. The insulator support portion 12b is disposed in parallel to the width direction D2. The insulator support portion 12b faces or abuts the support surface 33a or the support surface 34a of the fixing insulator 11. The insulator lock portion 12c is locked with the fixing insulator 11. This allows the insulator support portion 12b to be positioned immediately beneath the beam portion 33 or the beam portion 34.

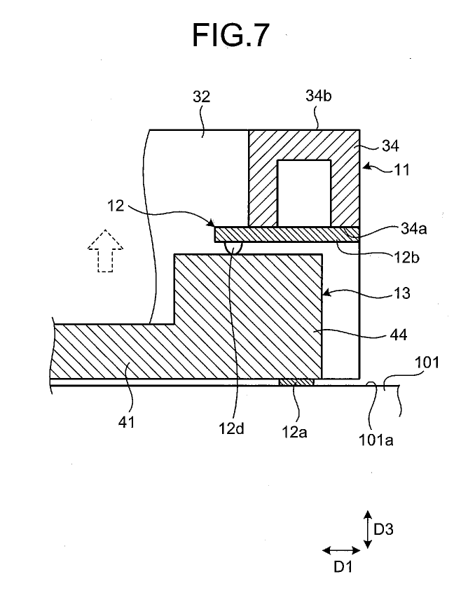

FIG. 7 is a diagram illustrating a configuration taken along A-A of FIG. 4 in cross-section. As illustrated in FIG. 7, the insulator support portion 12b includes a protrusion portion 12d. The protrusion portion 12d protrudes from the insulator support portion 12b toward the movable insulator 13. The protrusion portion 12d is formed in, for example, a semispherical shape. FIG. 7 illustrates the configuration in which the single protrusion portion 12d is provided. However, the configuration does not limit embodiments, and may have two or more protrusion portions 12d.

The movable insulator 13 is formed by using, for example, a resin material. The movable insulator 13 is provided inside the fixing insulator 11. The movable insulator 13 is disposed with a spacing from the substrate surface 101a. The movable insulator 13 includes a contact holding portion 41, an insert hole 42, a lock portion 43, and a lock portion 44.

The contact holding portion 41 extends in parallel to the contact array direction D1. The contact holding portion 41 holds the contacts 14. The contact holding portion 41 includes groove portions 41b (see FIG. 3) that hold the contacts 14. The groove portions 41b, the number of which corresponds to the number of the contacts 14, are arranged alongside at a predetermined interval in the contact array direction D1.

The contact holding portion 41 is disposed with a spacing in the width direction D2 from the wall portion 31 and the wall portion 32 of the fixing insulator 11. The contact holding portion 41 is disposed with a spacing in the contact array direction D1 from the beam portion 33 and the beam portion 34 of the fixing insulator 11.

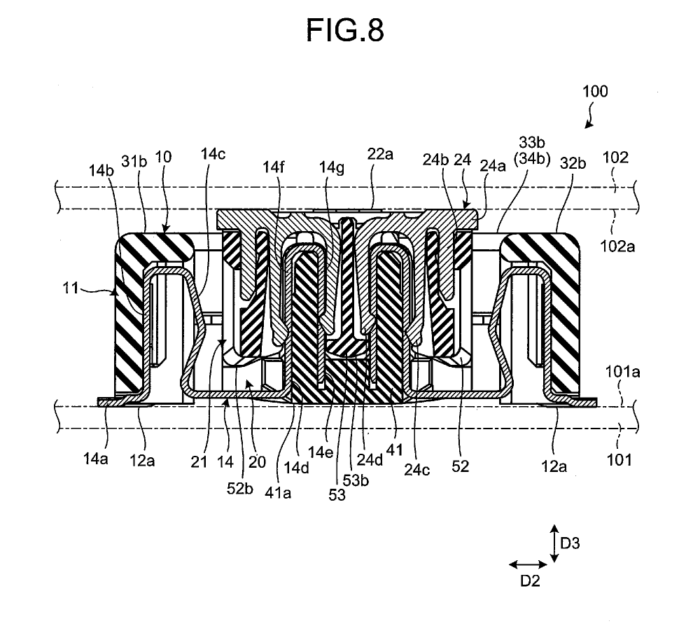

FIG. 8 is a diagram illustrating a configuration taken along B-B of FIG. 4 in cross-section. As illustrated in FIG. 8, the contact holding portion 41 includes a bottom surface portion 41a. The bottom surface portion 41a faces the substrate surface 101a of the first substrate 101. The bottom surface portion 41a has a shape in which the distance from a virtual plane S increases from the center to both ends in the width direction D2. The virtual plane S is a plane facing the bottom surface portion 41a. According to embodiments, for example, the substrate surface 101a is the virtual plane S. The bottom surface portion 41a may have a curved shape in which it is curved in its entirety in the width direction D2 or, a curved shape in which it is curved only at both ends in the width direction D2. The curved shape of the bottom surface portion 41a prevents the contact between the bottom surface portion 41a and the substrate surface 101a even when the movable insulator 13 sways with an angle relative to the virtual plane S (the substrate surface 101a) in the width direction D2. This allows improvement in fitting performance and prevents damage to the first connector 10 during fitting or after fitting when, for example, the second connector 20 is fitted to the first connector 10 in a tilted state with respect to the fitting direction D3.

The insert hole 42 is provided at the center of the contact holding portion 41 when viewed in the fitting direction D3. Part of the second connector 20 is inserted into the insert hole 42.

The lock portion 43 is disposed at one end of the contact holding portion 41 in the contact array direction D1. The lock portion 44 is disposed at the other end of the contact holding portion 41 in the contact array direction D1. The lock portion 43 and the lock portion 44 are each inserted between the insulator support portion 12b of the metal fitting 12 and the substrate surface 101a. Each of the lock portion 43 and the lock portion 44 is arranged facing the protrusion portion 12d of the insulator support portion 12b. The arrangement of the lock portion 43 and the lock portion 44 so as to face the protrusion portion 12d restricts the movement of the movable insulator 13 in the fitting direction D3. That is, the movable insulator 13 is held so as not to be removed from the fixing insulator 11. Since each of the lock portion 43 and the lock portion 44 is locally in contact with the protrusion portion 12d, not the entire insulator support portion 12b, sliding resistance is reduced.

A width L1 that is the dimension of the lock portion 43 and the lock portion 44 in the width direction D2 (the dimension in the width direction D2 is hereinafter referred to as a width) is larger than a width L2 of the contact holding portion 41 (see FIG. 4). The width L1 being larger than the width L2 allows the movable insulator 13 to have improved strength of the lock portion 43 and the lock portion 44.

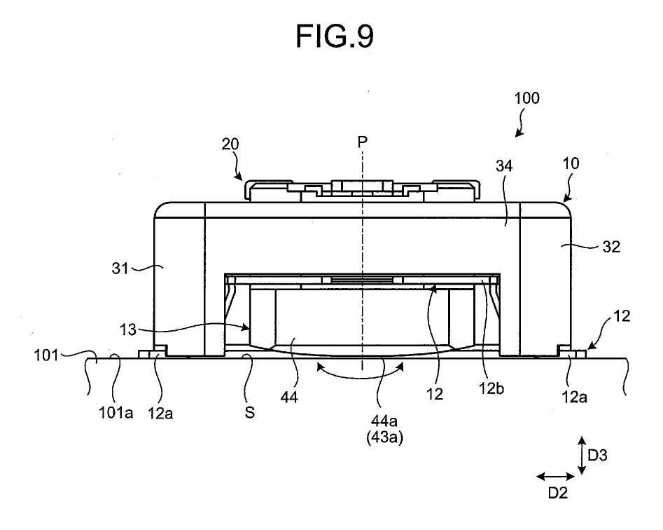

FIG. 9 is a side view illustrating an example of the connector 100. FIG. 9 illustrates the connector 100 when viewed from the beam portion 34 side of the first connector 10. As illustrated in FIG. 9, the lock portion 44 includes a bottom surface portion 44a. The bottom surface portion 44a faces the substrate surface 101a of the first substrate 101. The bottom surface portion 44a has a shape in which the distance from the virtual plane S increases from the center to both ends in the width direction D2. The virtual plane S is the plane facing the bottom surface portion 44a. According to embodiments, for example, the substrate surface 101a is the virtual plane S. The bottom surface portion 44a may have a curved shape in its entirety in the width direction D2 or a curved shape in which it is curved only at both ends in the width direction D2. The bottom surface portion 44a may be coplanar with the bottom surface portion 41a of the contact holding portion 41. A bottom surface portion 43a (see FIG. 4) of the lock portion 43 has the same configuration as that of the bottom surface portion 44a of the lock portion 44. The curved shapes of the bottom surface portion 43a and the bottom surface portion 44a prevent the contact between the bottom surface portion 43a and the bottom surface portion 44a and the substrate surface 101a even when the movable insulator 13 sways in the width direction D2. The first connector 10 thus allows the movable insulator 13 to sway in the width direction D2.

The contacts 14 are arranged alongside in the contact array direction D1. The contacts 14 are formed by, for example, conducting bending processing on a metallic material. The method for forming the contacts 14 is not limited to the bending processing, and the contacts 14 may be formed by, for example, conducing die-cut processing on a metallic material.

As illustrated in FIG. 8, the contacts 14 each include a mounting portion 14a, a first lock portion 14b, an elastic deformation portion 14c, a second lock portion 14d, a third lock portion 14e, a first connection portion 14f, and a second connection portion 14g. The mounting portion 14a is mounted on the substrate surface 101a. The first lock portion 14b is locked with the fixing insulator 11. The elastic deformation portion 14c is a portion that is disposed between the first lock portion 14b and the second lock portion 14d, and that can be elastically deformed. The second lock portion 14d and the third lock portion 14e are locked with the contact holding portion 41 of the movable insulator 13. The first connection portion 14f and the second connection portion 14g are in contact with a contact 24 of the second connector 20. The first connection portion 14f is disposed closer to the fixing insulator 11. The second connection portion 14g is disposed inside the insert hole 42.

The second connector 20 is fixed to a second substrate 102. The second connector 20 includes an insulator 21, metal fittings 22, and the contacts 24.

The insulator 21 is formed in a rectangular shape by using, for example, a resin material. The insulator 21 is disposed with a spacing from a substrate surface 102a of the second substrate 102. The insulator 21 includes a contact holding portion 51, an outer insertion portion 52, and an inner insertion portion 53.

The contact holding portion 51 is disposed facing the substrate surface 102a. The contact holding portion 51 extends in parallel to the contact array direction D1. The contact holding portion 51 holds the contacts 24. The contact holding portion 51 includes groove portions 51b (see FIG. 3) that hold the contacts 24. The groove portions 51b, the number of which corresponds to the number of the contacts 24, are arranged alongside at a predetermined interval in the contact array direction D1. The interval between the two adjacent groove portions 51b is the same as the interval between the two adjacent groove portions 41b of the contact holding portion 41 in the first connector 10.

The outer insertion portion 52 is integrally formed with the contact holding portion 51. The outer insertion portion 52 is formed in a ring shape (see FIG. 6). When the second connector 20 is fitted to the first connector 10, the outer insertion portion 52 is disposed between the wall portion 31, the wall portion 32, the beam portion 33, and the beam portion 34 of the fixing insulator 11 and the contact holding portion 41 of the movable insulator 13. In this case, the outer insertion portion 52 is provided at a position to surround the contact holding portion 41. The outer insertion portion 52 includes a fitting surface 52b caused to face the first connector 10 at the time of the fitting (see FIG. 6).

The inner insertion portion 53 is integrally formed with the contact holding portion 51. The inner insertion portion 53 is provided inside the outer insertion portion 52 (see FIG. 6). The inner insertion portion 53 is formed in a plate-like shape. The inner insertion portion 53 is inserted into the insert hole 42 of the movable insulator 13 when the second connector 20 is fitted to the first connector 10. The inner insertion portion 53 includes a fitting surface 53b caused to face the first connector 10 at the time of the fitting (see FIG. 6).

The metal fittings 22 have, for example, a plate-like shape. The metal fittings 22 each include a mounting portion 22a and an insulator lock portion 22b. One of the mounting portions 22a is provided at one end of the insulator 21 and another one of the mounting portions 22a at the other end of the insulator 21, and the mounting portions 22a are arranged in parallel to the substrate surface 102a. The mounting portion 22a is fixed to the substrate surface 102a. The insulator lock portion 22b is bent with respect to the mounting portion 22a toward the inside of the insulator 21. The insulator lock portion 22b is locked with the insulator 21 in a state of being inserted into a metal fitting holding section 21b of the insulator 21.

The contacts 24 are arranged alongside in the contact array direction D1. The contact 24 is formed by, for example, conducting die-cut processing on a metallic material. The method for forming the contacts 24 is not limited to the die-cut processing, and the contacts 24 may be formed by conducting, for example, bending processing on a metallic material.

The contacts 24 each include a mounting portion 24a, a lock portion 24b, a first connection portion 24c, and a second connection portion 24d. The mounting portion 24a is mounted on the substrate surface 102a. The lock portion 24b is locked with the contact holding portion 51 of the insulator 21. The first connection portion 24c is disposed on the inner periphery of the outer insertion portion 52. The first connection portion 24c is connected to the first connection portion 14f of the contact 14 provided in the first connector 10. The second connection portion 24d is disposed on the outer periphery of the inner insertion portion 53. The second connection portion 24d is connected to the second connection portion 14g of the contact 14 provided in the first connector 10.

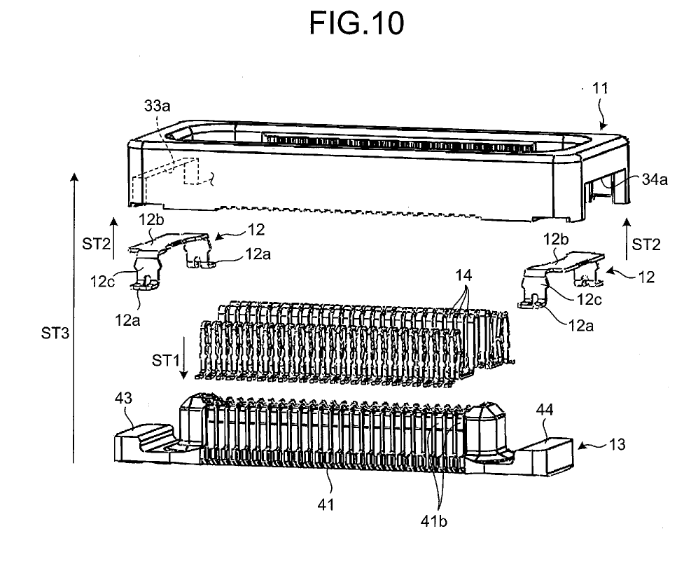

The following describes the steps for assembling the first connector 10 and the second connector 20. FIG. 10 is a diagram illustrating the flow of assembling the first connector 10. A first assembly step (ST1 in FIG. 10) will be explained. At the first assembly step, the contacts 14 are inserted into the groove portions 41b of the movable insulator 13 from above. This step allows the contacts 14 to be locked and held by the movable insulator 13.

A second assembly step (ST2 in FIG. 10) will be explained. At the second assembly step, the metal fittings 12 are inserted into the fixing insulator 11 from beneath. The insulator support portions 12b abut the support surface 33a and the support surface 34a of the fixing insulator 11. The step allows the insulator lock portions 12c to be locked with the fixing insulator 11. Thus, the metal fittings 12 are locked with the fixing insulator 11 in a state of being disposed inside the fixing insulator 11, i.e., in a state of being not exposed on the surface at the fitting side of the fixing insulator 11. Either one of the first assembly step and the second assembly step may be performed first.

A third assembly step (ST3 in FIG. 10) will be explained. At the third assembly step, the movable insulator 13 holding the contacts 14 is inserted into the fixing insulator 11, with which the metal fittings 12 are locked, from beneath. This step allows the movable insulator 13 to be disposed inside the fixing insulator 11 in a state where the lock portion 43 and the lock portion 44 of the movable insulator 13 face or abut the respective metal fittings 12. Assembling of the first connector 10 is thus completed.

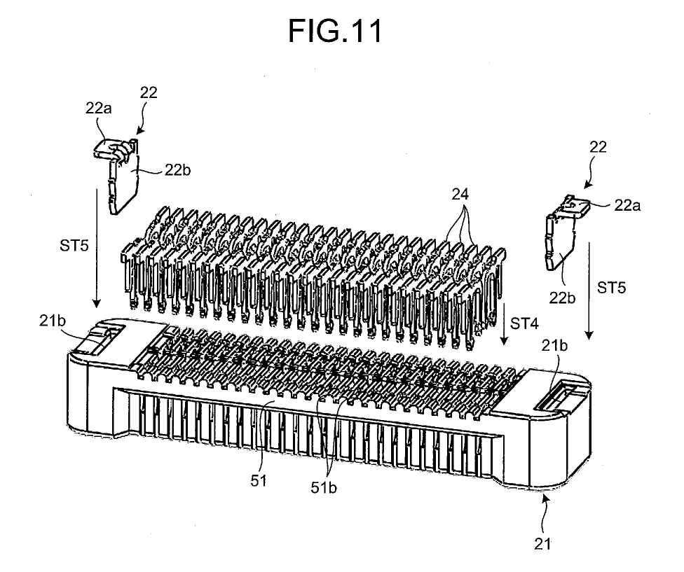

FIG. 11 is a diagram illustrating the flow of assembling the second connector 20. A fourth assembly step (ST4 in FIG. 11) will be explained. At the fourth assembly step, the contacts 24 are inserted into the groove portions 51b of the insulator 21 from above. The step allows the contacts 24 to be locked and held by the insulator 21.

A fifth assembly step (ST5 in FIG. 11) will be explained. At the fifth assembly step, the metal fittings 22 are inserted into the respective metal fitting holding sections 21b of the insulator 21 from above. The insulator lock portions 22b are locked with the insulator 21 inside the respective metal fitting holding sections 21b. Assembling of the second connector 20 is thus completed. Either one of the fourth assembly step and the fifth assembly step may be conducted first.

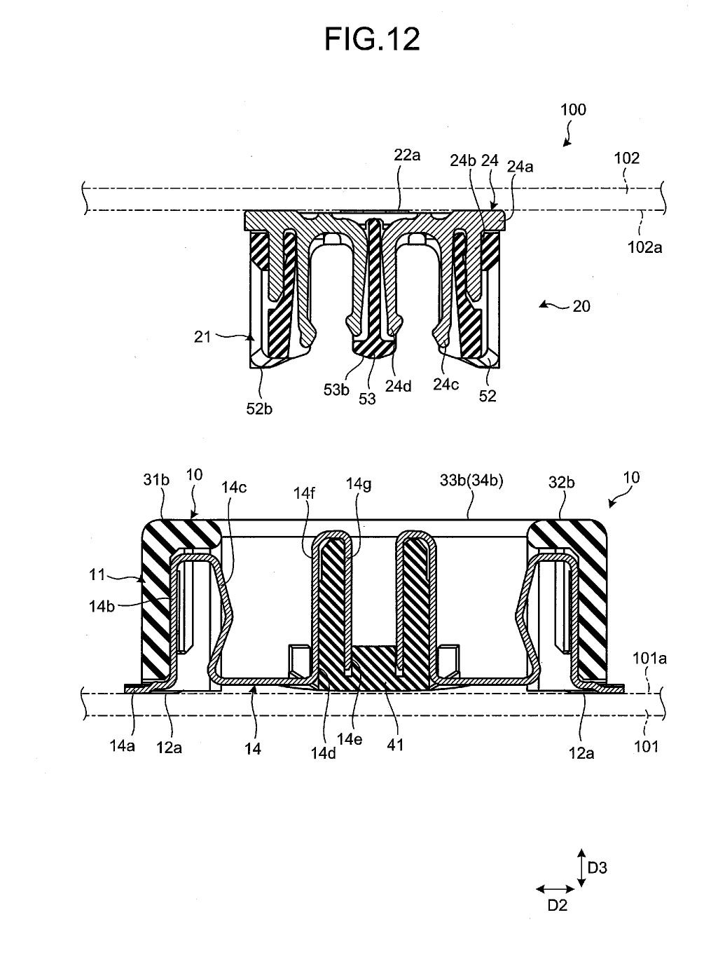

FIG. 12 is a diagram illustrating a state where the first connector 10 faces the second connector 20. When the first connector 10 and the second connector 20 are fitted to each other, as illustrated in FIG. 12, the fitting surface 31b, the fitting surface 32b, the fitting surface 33b, and the fitting surface 34b of the first connector 10 face the fitting surface 52b and the fitting surface 53b of the second connector 20. In this state, the first connector 10 and the second connector 20 are moved relative to each other to adjust positions.

At the time of the positional adjustment, for example, the fixing insulator 11 of the first connector 10 and the insulator 21 of the second connector 20 are brought into contact with each other, and caused to slide in a direction perpendicular to the fitting direction D3. In the first connector 10, the fitting surface 31b, the fitting surface 32b, the fitting surface 33b, and the fitting surface 34b of the fixing insulator 11 are flat. Consequently, the second connector 20 smoothly moves on the fitting surface 31b, the fitting surface 32b, the fitting surface 33b, and the fitting surface 34b.

The positional adjustment allows the outer insertion portion 52 of the insulator 21 to be inserted between the fixing insulator 11 and the contact holding portion 41 of the first connector 10, and allows the inner insertion portion 53 to be inserted into the insert hole 42. This allows fitting among the fixing insulator 11, the movable insulator 13, and the insulator 21. The fitting brings the first connection portion 24c of the contact 24 in contact with the first connection portion 14f of the contact 14. The fitting also brings the second connection portion 24d of the contact 24 in contact with the second connection portion 14g of the contact 14. Consequently, the contacts 14 are electrically connected to the contacts 24.

If relative force is applied between the first substrate 101 and the second substrate 102 in the width direction D2 when or after the outer insertion portion 52 and the inner insertion portion 53 are inserted, the movable insulator 13 sways in the width direction D2. Accordingly, when the fixing insulator 11 and the movable insulator 13 of the first connector 10 are fitted to the insulator 21 of the second connector 20 in a state of being shifted in the width direction D2, for example, the positional relation between the first connector 10 and the second connector 20 is easily corrected by the movable insulator 13 swaying in the width direction D2. Since the bottom surface portion 41a, the bottom surface portion 43a, and the bottom surface portion 44a are curved, the bottom surface portion 41a, the bottom surface portion 43a, and the bottom surface portion 44a are prevented from being in contact with the substrate surface 101a even when the movable insulator 13 sways in the width direction D2.

When the second connector 20 is removed from the first connector 10, force is applied to the first substrate 101 and the second substrate 102 in a direction to separate from each other. This force pulls the contact holding portion 41 toward the second connector 20, and the lock portion 43 and the lock portion 44 press the respective insulator support portions 12b of the respective metal fittings 12 toward the second connector 20. Accordingly, the metal fittings 12 restrict the movement of the movable insulator 13 toward the second connector 20.

At this time, force directed to the second connector 20 side is applied to the lock portion 43 and the lock portion 44. As the lock portion 43 and the lock portion 44 have the width L1 that is larger than the width L2 of the contact holding portion 41 and have improved strength, they are held by the respective insulator support portions 12b of the respective metal fittings 12 without any damage or the like. As the metal fittings 12 are made of metal and fixed to the substrate surface 101a of the first substrate 101 with the mounting portions 12a, they are not deformed or separated from the substrate surface 101a, whereby the movement of the movable insulator 13 toward the second connector 20 is reliably restricted. Since direct application of force from the lock portion 43 and the lock portion 44 to the fixing insulator 11 is avoided, damage or the like to the fixing insulator 11 is prevented.

Accordingly, without any damage or the like to the fixing insulator 11 and the movable insulator 13, the outer insertion portion 52 of the insulator 21 is pulled out from between the fixing insulator 11 and the contact holding portion 41, and the inner insertion portion 53 is pulled out from the insert hole 42. Thus, the first connection portion 24c and the first connection portion 14f are separated from each other, and the second connection portion 24d and the second connection portion 14g are separated from each other. As a result, the contact 14 and the contact 24 are electrically disconnected.

As described above, in the connector 100 according to embodiments, the lock portion 43 is disposed at one end of the movable insulator 13 in the contact array direction D1 and the lock portion 44 at the other end of the movable insulator 13 in the contact array direction D1 such that the lock portions 43 and 44 face the respective metal fittings 12. Accordingly, if the movable insulator 13 is pulled toward the second connector 20 when the second connector 20 is removed from the first connector 10 or when unintentional force is applied, the metal fittings 12 restrict the movement of the movable insulator 13 in the fitting direction D3 (in the direction to remove the second connector 20). This prevents direct application of force from the movable insulator 13 to the fixing insulator 11, thereby preventing damage to the fixing insulator 11 during removal or in the case of unintentional force being applied. In the connector 100, the metal fittings 12 are locked with the fixing insulator 11 in a state of being disposed inside the fixing insulator 11, i.e., in a state of being not exposed on the fitting surface 31b, the fitting surface 32b, the fitting surface 33b, and the fitting surface 34b of the fixing insulator 11. Accordingly, in comparison with a case where the metal fittings 12 are disposed on the surface of the fixing insulator 11, damage to other connectors caused by metallic fittings is suppressed, or unevenness of the surface of the fixing insulator 11 is reduced. This allows the second connector 20 to smoothly slide on the surface of the fixing insulator 11 when the first connector 10 and the second connector 20 are fitted to each other, thereby making the second connector 20 easily inserted into the first connector 10. In this way, the connector 100 can reduce its size, prevent a decrease in strength, and improve fitting performance when the first connector 10 and the second connector 20 are fitted to each other.

In the connector 100 according to embodiments, the movable insulator 13 has the lock portion 43 and the lock portion 44, the width L1 of which is larger than the width L2 of the contact holding portion 41. Accordingly, even when the width L2 of the contact holding portion 41 is made smaller for downsizing, a reduction in strength of the movable insulator 13 can be prevented.

In the connector 100 according to embodiments, the entire surfaces of the fitting surface 31b, the fitting surface 32b, the fitting surface 33b, and the fitting surface 34b are exposed to the second connector 20. In the connector 100 according to embodiments, the fitting surface 31b, the fitting surface 32b, the fitting surface 33b, and the fitting surface 34b for guiding the second connector 20 are coplanar and flat surfaces in the fixing insulator 11. In the connector 100 according to embodiments, the fitting surface 31b, the fitting surface 32b, the fitting surface 33b, and the fitting surface 34b are flat and continuously formed on the whole circumference of the fixing insulator 11. Accordingly, even when an operator tries to fit the first connector 10 to the second connector 20 in a state of being shifted from the normal position, the second connector 20 can smoothly move on the fitting surface 31b, the fitting surface 32b, the fitting surface 33b, and 34b, and they are not damaged by metallic fittings or the like. This allows the second connector 20 to be easily and securely guided, thereby improving operational performance for fitting task.

In the connector 100 according to embodiments, the bottom surface portion 41a and the bottom surface portion 44a of the movable insulator 13 facing the substrate surface 101a have a shape in which the distance from the substrate surface 101a increases from the center to both ends in the width direction D2. Accordingly, even when the movable insulator 13 sways in the width direction D2, the bottom surface portion 41a and the bottom surface portion 44a can be prevented from being in contact with the substrate surface 101a.

The technical scope of the present invention is not limited to embodiments, and modifications may be appropriately made without departing from the scope of the present invention. The explanation given to embodiments takes an example in which, at a contact portion between the insulator support portion 12b and each of the lock portion 43 and the lock portion 44, the protrusion portion 12d is provided to the insulator support portion 12b. However, embodiments are not limited thereto. For example, the protrusion portion may be provided to each of the lock portion 43 and the lock portion 44. The protrusion portions may be provided to both the insulator support portions 12b and to the lock portion 43 and the lock portion 44.

The explanation given to embodiments takes an example in which the bottom surface portion 41a, the bottom surface portion 43a, and the bottom surface portion 44a of the movable insulator 13 each have a curved shape. However, embodiments are not limited thereto. The shape of the movable insulator 13 may be other shapes as long as the bottom surface portion 41a, the bottom surface portion 43a, and the bottom surface portion 44a are configured not to be in contact with the substrate surface 101a when the movable insulator 13 sways in the width direction D2. For example, the bottom surface portion 41a, the bottom surface portion 43a, and the bottom surface portion 44a may have a planar shape parallel to the virtual plane S (the substrate surface 101a) at the central part in the width direction D2, and have a curved shape partially at both ends in the width direction D2. For example, the bottom surface portion 41a, the bottom surface portion 43a, and the bottom surface portion 44a may have a planar shape (inclined plane), in which the distance from the substrate surface 101a increases from the center to both ends in the width direction D2. In this case, the inclined plane may be provided entirely from the center to both ends in the width direction D2, or the inclined plane may be provided partially at both ends in the width direction D2, while the central part in the width direction D2 has a planar shape parallel to the virtual plane S (the substrate surface 101a).

### REFERENCE SIGNS LIST

D1 CONTACT ARRAY DIRECTION
D2 WIDTH DIRECTION
D3 FITTING DIRECTION
L1 WIDTH
L2 WIDTH
S VIRTUAL PLANE
10 FIRST CONNECTOR
11 FIXING INSULATOR
12, 22 METAL FITTING
12a, 22a MOUNTING PORTION
12b INSULATOR SUPPORT PORTION
12c, 22b INSULATOR LOCK PORTION
12d PROTRUSION PORTION
13 MOVABLE INSULATOR
14, 24 CONTACT
14a MOUNTING PORTION
14b FIRST LOCK PORTION
14c ELASTIC DEFORMATION PORTION
14d SECOND LOCK PORTION
14e THIRD LOCK PORTION
14f FIRST CONNECTION PORTION
14g SECOND CONNECTION PORTION
20 SECOND CONNECTOR
21 INSULATOR
24a MOUNTING PORTION
24b LOCK PORTION
24c FIRST CONNECTION PORTION
24d SECOND CONNECTION PORTION
31, 32 WALL PORTION
31b, 32b, 33b, 34b FITTING SURFACE
33, 34 BEAM PORTION
33a, 34a SUPPORT SURFACE
41, 51 CONTACT HOLDING PORTION
41a, 43a, 44a BOTTOM SURFACE PORTION
42 INSERT HOLE
43, 44 LOCK PORTION
52 OUTER INSERTION PORTION
53 INNER INSERTION PORTION
52b, 53b FITTING SURFACE
100 CONNECTOR
101 FIRST SUBSTRATE
102 SECOND SUBSTRATE
101a, 102a SUBSTRATE SURFACE

1. A connector including a plurality of electrically conducting contacts and fitted to another connector, said connector comprising:
a fixing insulator having a frame shape;
a plurality of metal fittings that are disposed at both ends of said fixing insulator in a contact array direction in which said contacts are arrayed, and that are provided inside said fixing insulator; and
a movable insulator that is disposed inside said fixing insulator, that is connected to said fixing insulator through elastic deformation portions of said contacts, and that is movable at least in a direction perpendicular to a fitting direction of said fitting to said other connector by elastic deformation of said elastic deformation portions, both ends of said movable insulator in said contact array direction, in which said contacts are arrayed, facing said respective metal fittings.

2. The connector according to claim 1, wherein said both ends of said movable insulator in said contact array direction, in which said contacts are arrayed, are formed to be wider than a central part of said movable insulator in a width direction orthogonal to said contact array direction, in which said contacts are arrayed, on a plane perpendicular to said fitting direction of said fitting to said other connector.

3. The connector according to claim 1, wherein both ends of said movable insulator in said contact array direction, in which said contacts are arrayed, are restricted by said metal fittings when removed from said other connector.

4. The connector according to claim 1, wherein said fixing insulator includes a fitting surface in said fitting direction of said fitting to said other connector, said fitting surface being formed of only said fixing insulator.

5. The connector according to claim 4, wherein said fitting surface is flat and provided in an identical plane.

6. The connector according to claim 4, wherein said fitting surface is flat and continuously formed on a whole circumference of said fixing insulator.

7. The connector according to claim 1, wherein a bottom surface of said movable insulator on an opposite side of a fitting surface side fitted to said other connector has a shape in which a distance from a virtual plane facing said bottom surface increases from a center to an end in a direction perpendicular to said fitting direction of said fitting to said other connector.
